(19) United States
(12) Patent Application Publication
(10) Pub. No.: US 2010/0054255 A1
(43) Pub. Date: Mar. 4, 2010

(54) Home Network Server in an Operator Network

(75) Inventors: Staffan Bonnier, Askim (SE); Hans-Ake Lund, Bohus (SE); Sten Pettersson, Torslanda (SE); Staffan Winell, Askim (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 12/520,827

(22) PCT Filed: Dec. 22, 2006
(86) PCT No.: PCT/SE2006/050618

§ 371 Date: Jun. 22, 2009

(51) Int. Cl. H04L 12/56

(52) U.S. Cl. 370/395.1

(57) ABSTRACT

The invention discloses a Home Virtual Private Network server (250), a Home VPN server, for use in a communications operator network (120), which network (120) can communicate with a subscriber network (130), and in which operator network a first protocol on a first level is used. The subscriber network (130) can accommodate at least one subscriber with one subscriber device (131-135) and a communications device (140) which can connect the subscriber to the operator network (120). The Home VPN server (250) comprises functions for: translating IP-addresses and port numbers of IP-packets which are sent between the operator network and the subscriber network, assigning individual IP-addresses to devices in the subscriber network, routing IP-traffic from the operator network to devices in the subscriber network, to which functions the subscriber can connect via said communications device (140) in order to utilize his network (130) as a Home VPN.

### TECHNICAL FIELD

The present invention relates to a server for use in a communications operator network which can communicate with at least one Home Virtual Private Network, a Home VPN. The Home VPN is able to accommodate at least a first subscriber with a first subscriber device and a communications device by means of which said first subscriber can connect to the operator network, and the server of the invention is a Home VPN server.

### BACKGROUND

In a private subscriber's broadband network, there may be a number of devices attached to the local network, examples of which are PCs, telephones, set-top boxes, printers, and disks.

In particular, a private broadband network which connects to an external network such as the Internet will comprise a so called Customer Premise Equipment, a CPE, which implements a number of functions required to provide connectivity between each of the end-user devices in the private network and services provided in (or via) the external network by the Service Provider who operates the external network.

In systems such as the one described briefly above, there is a problem in that the operator network is unable to discriminate IP-packets of individual subscribers and/or devices “behind” a NAPT, i.e. devices in the private network. One drawback of this is that session continuity cannot be provided if a user device moves outside the CPE, i.e. away from the private network, which will usually be the case when a user device is moved from the user's home.

### SUMMARY

As indicated above, there is thus a need for a solution by means of which an operator network can provide session continuity for devices in a private network which is connected to the operator network even when those devices move outside of the home of the subscriber of the private network.

There is also a need for a solution which is able to provide authentication and policy control for each device in the private network, without creating a need for additional firewall or other security software in the subscriber devices.

These needs are addressed by the present invention in that it provides a server for use in a communications operator network, which network can communicate with at least one Home Virtual Private Network, a Home VPN.

The Home VPN is able to accommodate at least a first subscriber with a first subscriber device and a communications device by means of which the first subscriber can connect to the operator network. The server of the invention is a Home VPN server, which comprises functions for:
Hosting a number of Home VPNs,
Letting a device in a Home VPN request access to a specific Home VPN hosted by the Home VPN server,
Creating a Home VPN device session in a Home VPN for a device which successfully authenticates for that Home VPN.

In a preferred embodiment, the Home VPN server of the invention additionally comprises means for letting:
A Home VPN have one or more associated Home VPN users, each with an individual Home VPN user profile, with said profile specifying policies governing the access to Home VPN services for that user,
A Home VPN user be authenticated for association with a device session,
The Home VPN server enforce service access policies defined by the user's individual profile on that device session.

The invention is also directed towards an operator network which comprises a Home VPN server with the features mentioned above.

Thus, as will be realized more clearly by means of the detailed description given below, an operator network can now allow a more individual tailoring of services for each device in a Home VPN, as well as allowing for the possibility of increased mobility of the devices in the Home VPN.

Suitably, the Home VPN server of the invention comprises a Point of Presence, PoP, in which the functions mentioned above are comprised, and to which a Home VPN can connect via said communications device.

### BRIEF DESCRIPTION OF THE DRAWINGS

The invention will be described in more detail in the following with reference to the appended drawings, in which

FIG. 1 shows an operator network of a known kind, and

FIG. 2 shows a server of the invention applied to the system of FIG. 1, and

FIG. 3 shows a possible location of the invention,

FIG. 4 shows a possible application of the invention.

### DETAILED DESCRIPTION

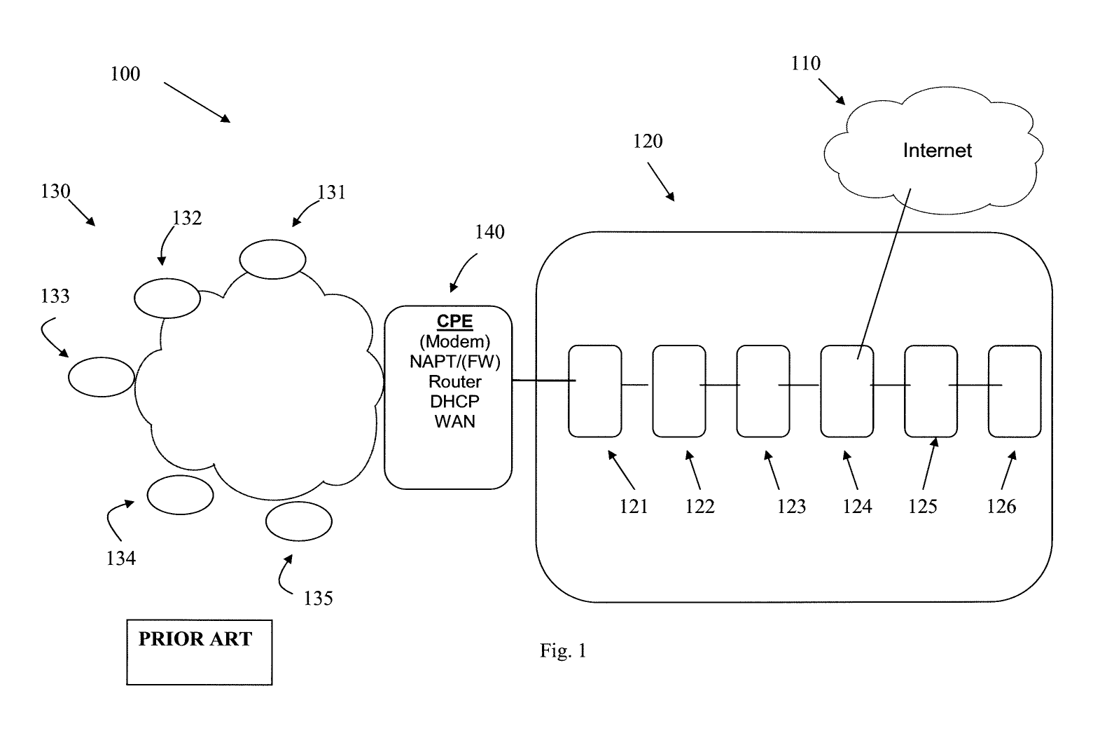

In order to facilitate the understanding of the invention, a traditional system with an operator network and a home network will first be described, with reference to FIG. 1.

The system 100 of FIG. 1 comprises a private network 130, which in turn comprises a number of subscriber devices, 131-135. Examples of such devices are PCs, telephones, printers, etc.

The private network 130 connects to the operator network 120 via a so called CPE, Customer Premise Equipment, 140. The CPE implements a number of functions which are needed for the private network 130 to connect to the operator network 120.

Typically, examples of such functions which are implemented in the CPE 140 are:
A modem, for establishing a communication link between the private network and a local access node in the operator's network.
A WAN-interface to which the operator may assign a routable IP-address.
A Network Address and Port Translator (NAPT), translating IP-addresses and UDP/TCP-port numbers of IP-packets traversing the NAPT.
A Firewall (FW) for filtering incoming traffic to the subscriber's private network.
A DHCP server that assigns private IP-addresses to each device in the subscriber network.
A Router routing IP-traffic to the devices in the subscriber network.

Naturally, if these functions can be implemented by other means than those enumerated above, that would usually also be a satisfactory solution. The means given above are merely examples of how the functions may be implemented.

Note that not all of these functions may be necessary in all applications. For example, there may be private networks for which no modem is required. Which of the functions enumerated above that are necessary will be decided for each private network on an individual basis. Another example of a more or less optional function in the CPE is the firewall, not all users may desire to have firewalls to protect their private networks.

The private network connects to an external network 110 such as, for example, the Internet, by means of the operator network 120.

The operator network 120 typically comprises the following functions:
An Access Node 121
An Access Network 122
An Access Edge 123, which is the point where the access network connects with the operator's backbone.
A Backbone Network 124.
A service edge 125, which is the point where the backbone connects to the service network.
A service network 126.

The functions 121-126 which are comprised in the operator network 120 are well known to those skilled in the field, and will thus not be described in more detail here.

As stated previously, one of the objects of the present invention is to let the operator network allow for a more individual tailoring of services for each device in a Home VPN, as well as allowing for the possibility of increased mobility of the devices in the Home VPN.

In order to achieve this and other goals which will be stated below, the present invention introduces the idea of a Home VPN server. Before the Home VPN server of the invention is described in more detail, the basic notion of the Home VPN server will first be explained:

A Home VPN server of the invention can maintain or host a number of Home VPNs, and each Home VPN has an associated set of Home VPN services accessible via the Home VPN server.

A Home VPN device may request access to a specific Home VPN served by the Home VPN server. If the device is successfully authenticated for that Home VPN, the Home VPN server creates a Home VPN device session.

A Home VPN may have one or more associated Home VPN users, each with an individual Home VPN user profile. The profile specifies policies governing the access to Home VPN services for that user. A Home VPN user may be authenticated for association with a device session. The Home VPN server then enforces the service access policies defined by the user's individual profile on that device session.

It should be pointed out that the invention does not impose any restrictions or limitations on the type or location of the Home VPN device, nor on the access technology used for accessing the Home VPN.

In the following, some examples of specific technical implementation of a Home VPN server will be discussed, in which a subscriber's L2 protocol layer network is extended into the operator's domain, so that the Home VPN server of the invention may be implemented.

Technically, the Home VPN server is implemented by bridging the subscriber's CPE, and tunnelling the subscriber's L2 traffic to a Home VPN PoP (point of presence) in the operator's network.

At the Home VPN PoP, the operator hosts functions that were previously implemented by the CPE. Typical examples of such functions are functions for:
translating IP-addresses and port numbers of IP-packets which are sent between the operator network and the subscriber network, usually carried out by the NAPT,
assigning individual IP-addresses to each device in the subscriber network, usually carried out by the DHCP,
routing IP-traffic from the operator network to the devices in the subscriber network, usually carried out by the Router function in the CPE.

In other words, the operator maintains one so called Home VPN context per Home VPN subscriber. The Home VPN context implements one instance of each function that the operator hosts for the Home VPN subscriber.

In particular, the operator may host one Mobile IP (MIP) Home Agent per Home VPN, enabling Home VPN users to move with a device, while still maintaining its private IP-address of the Home VPN.

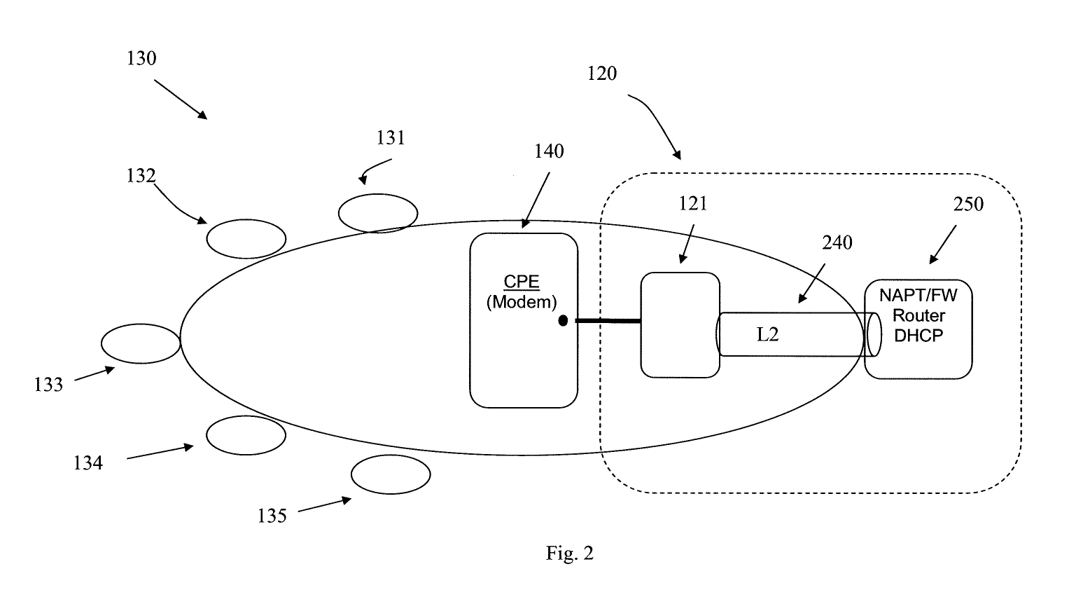

Thus, a fundamental idea of this invention is to introduce the notion of Home VPN, where the subscriber's L2 network is extended into the operator's domain. This is illustrated in FIG. 2, which shows a system 130 similar to the traditional one shown in FIG. 1 and described above, but in which a Home VPN server 250 of the invention is implemented and employed.

Components or functions in FIG. 2 which have already been shown in FIG. 1 are given the same reference numerals in FIG. 2, and are not described again here. (This principle is adhered to throughout the drawings attached to this text.)

As indicated in FIG. 2, the Home VPN server 250 of the invention is reached from the Home VPN 130 by bridging the subscriber's CPE 140, and tunnelling the subscriber's L2 traffic to a Home VPN PoP, point of presence, 250, in the operator's network 120. The tunnel for the subscriber's L2 traffic is shown as 240 in FIG. 2.

At the Home VPN PoP 250, the operator hosts functions that were previously implemented by the CPE, in this example the NAPT, DHCP, Router, and, optionally, a firewall, with the modem, if one is needed, being retained in the CPE.

This can also be described as saying that the operator maintains one Home VPN context 250 per Home VPN subscriber.

The CPE as such is not a part of this invention, and most commercially available CPEs can be used together with the Home VPN server of the invention, i.e. they can be “bridged” by a setting available to the user or the operator. The meaning of the verb “bridged” here is that the CPE will let data packets from the user pass through the CPE to the Home VPN server whilst letting them maintain their address, by means of which the Home VPN server can identify the Home VPN device from which they originated. This address is in most embodiments of the invention the IP-address of the Home VPN-device.

Again, it can be pointed out that most CPEs on the market today may be bridged. For DSL modems, this function is required by the DSLF standards. That is, the invention does not impose any new requirements on end-user equipment. Other access technologies, such as FTTx (Fibre To The home/curb/...), also support bridged and transparent access from the CPE.

Thus, by means of the invention, each user in the Home VPN 130 may be authenticated separately, and it should be noted that each Home VPN subscriber may comprise several users.

During the authentication procedure, an authentication state is created in the Home VPN context, associating the user with the device's IP address and downloading the user's policy profile from an AAA-server. The AAA-server is not shown in the drawings, since it is not a part of the invention, and will not be described in detail here, since it is well known to those skilled in the field.

Now. “per user” policy settings may be enforced at the Home VPN PoP. A number of different authentication mechanisms may be used, including EAP-based methods (Extensible Authentication Protocol). However, the authentication procedure, as well as the choice of authentication method is outside the scope of this invention, and will thus not be elaborated upon here.

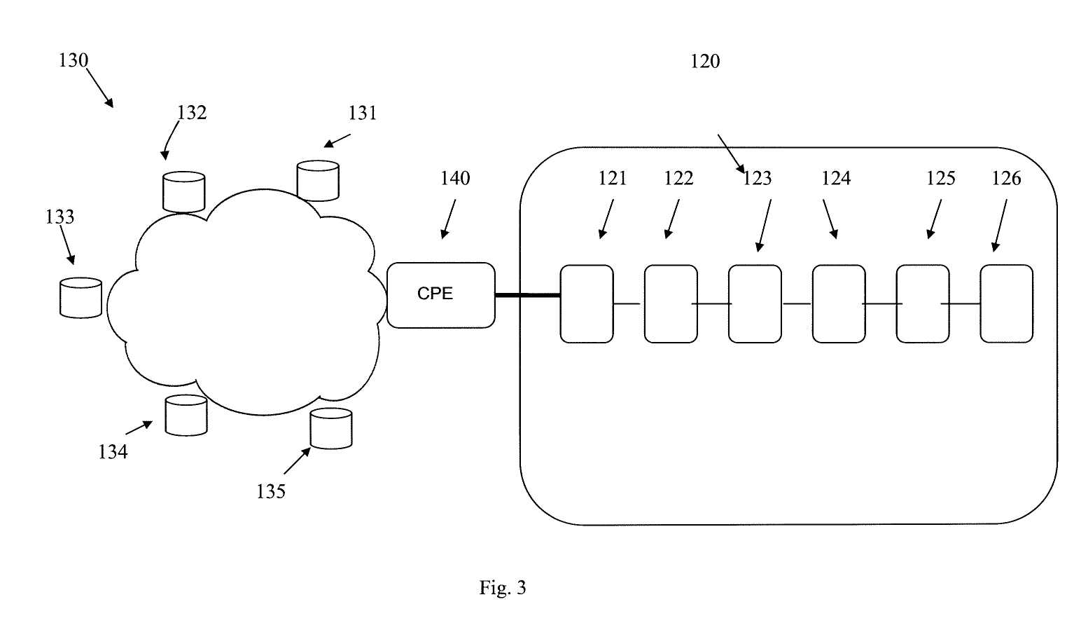

There are two places in the operator network where Home VPN contexts and thus the Home VPN server 250 of the invention may be implemented, as shown in FIG. 3: The Home VPN server 250 may be best implemented either at the Access Edge 123, or at the Service Edge 125 of the operator's network 120. The invention naturally covers both of these options, but a few words can be said about the different advantages offered by these two options:

Deployment at the Access Edge 123 only requires simple tunnelling mechanisms through the access network 122 (e.g. MAC-in-MAC), while only enabling Home VPN service delivery to customers within a restricted area.

Deployment at the Service Edge 125 makes it possible to offer the Home VPN Server of the invention to a broader customer range, while requiring more complex L2 tunnelling mechanisms through the backbone network 124. An example of such a mechanism which can be mentioned is VPLS, Virtual Private LAN Services.

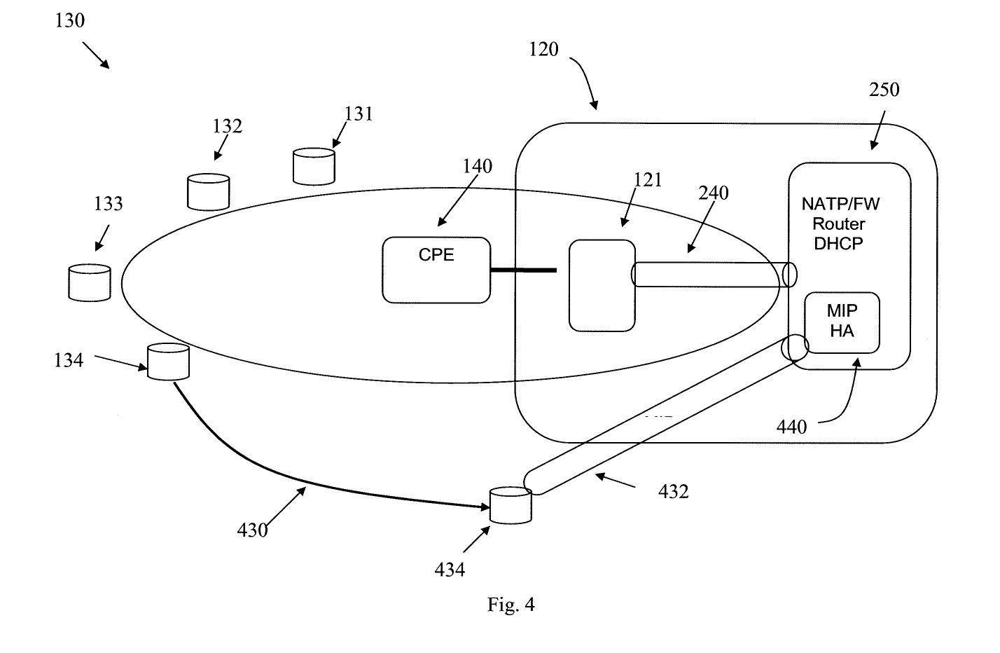

Another advantage offered by the Home VPN server solution of the invention is that it opens for so called “nomadic access” to the Home VPN with IP-session continuity using Mobile IP, “MIP”. This is illustrated in FIG. 4, which shows a Home VPN server 250 of the invention, but which is now provided with one instance 440 of a MIP Home Agent, “HA”, per Home VPN context.

As is also shown in FIG. 4, if MIP is used, a device 134 which uses the MIP service has a co-located “c/o address” 434 which addresses the MIP HA 440 through a special data tunnel 432.

The MIP HA 440 advertises its presence to all of the devices on the Home VPN's LAN 130 by means of a broadcast message, and the MIP has a tunnel 432 to the Home VPN Server 250 which is terminated behind the Home VPN's NAT.

By having an instance 440 of a MIP Home Agent per Home VPN, a Mobile Node 134 may preserve its home address on the Home VPN when moving to a different location. As mentioned above, this property is also known as session continuity, since application sessions survive the change of location, even if the application cannot handle a change of IP-address.

Note that security issues, such as authentication of the Mobile Node 134, may be handled according to well known standards for such issues, and will thus not be discussed here.

Clearly, all types of services may be hosted in the Home VPN context of a Home VPN as discloses by the invention. For instance, an operator may provide a hosted disk, and make one partition available to each Home VPN

One issue that has not been touched upon hitherto, but which deserves special attention is that the L2 tunnel between the Home VPN server and the Home VPN may be implemented using MAC-in-MAC, or another L2 tunnel mechanism that will hide the user MAC-addresses from the aggregation network, unless the aggregation network can handle the required MAC address capacity by other means

11 In addition to MAC address hiding, the invention may be combined with standard techniques to ensure a sufficient level of security, and to avoid eaves-dropping between different Home VPN subscribers sharing the same physical Metro Ethernet. This includes, for example, so called MAC Forced Forwarding for traffic separation.

Thus, as shown in the description given above an as will have been understood by one skilled in the art, a number of advantages are offered by the invention. Examples of such advantages which can be mentioned are that the invention:
enables policy settings and policy enforcement per user within the Home VPN.
enables nomadic access with IP-session continuity to the Home VPN.
provides a uniform framework for hosting services within the Home VPN.
is independent of the access technology that is used.
only requires bridging capabilities from the CPE. That is, all requirements imposed by the solution are already met by most CPEs on the market.

It can also be pointed out that thanks to the invention, the connection between the home VPN device 131-135 has been made independent of the access type to the Home VPN server 250.

1-14. (canceled)

15. A communications operator network for providing session continuity for a communications device in a Home Virtual Private Network (Home VPN), the communications operator comprising:
a Home VPN server for communicating with the Home VPN, the Home VPN server being arranged for hosting a number of home VPNs, allowing a device in the Home VPN to request access to a specific Home VPN hosted by the Home VPN server and creating a Home VPN device session in the specific Home VPN for the device if the device is authenticated for the specific Home VPN.

16. The communications operator network of claim 15, wherein the Home VPN server is further arranged for allowing one or more associated Home VPN users, each user having a Home VPN user profile, said profile specifying policies governing access, by said each user, to the Home VPN.

17. The communications operator network of claim 15, wherein the Home VPN server is further arranged for authenticating each user for a device session, wherein said access policies are defined by the Home VPN user profile.

18. The communications operator network of claim 15, wherein the Home VPN server comprises:
a Point of Presence (Home VPN PoP), wherein the Home VPN can connect to the Home VPN server by the communications device;
a Network Address and Port translator (NAPT) for translating IP-addresses and port numbers of IP-packets which are sent between the operator network and the subscriber network,
a DHCP for assigning individual IP-addresses to each device in the subscriber network; and ‘a router for routing IP-traffic from the communications operator network to the devices in the subscriber network.

19. The communications operator network of claim 15, wherein the communications device is a customer premise equipment (CPE) and the Home VPN connects to the communications operator network via the CPE, by tunneling the.

20. The communications operator network of claim 15, in which the communications device of the Home VPN can connect to the Home VPN PoP if the communications device is able to map a second L2 protocol which is used in the Home VPN to a first L2 protocol in the operator network via a “null-mapping” function which preserves the address of a subscriber device by means of which the Home VPN server can identify the subscriber device in the Home VPN.

21. The communications operator network of claim 15, in which the Home VPN server comprises one Home VPN context per Home VPN subscriber, said context containing one instance of each function that the operator hosts for the Home VPN subscriber.

22. The communications operator network of claim 21, in which said context can comprise a plurality of users for the Home VPN of that context, each user having individual user profiles with regard to which services of the Home VPN that they may access.

23. A Home Virtual Private Network (Home VPN) server in a communications operator network, for communicating with a Home VPN, the Home VPN server being arranged for
hosting a number of Home VPNs,
allowing a device in the Home VPN to request access to a specific Home VPN hosted by the Home VPN server and
creating a Home VPN device session in the specific Home VPN for the device if the device is authenticated for the specific Home VPN.

24. The Home VPN server of claim 23, wherein the Home VPN server is further arranged for allowing one or more associated Home VPN users, each user having a Home VPN user profile, said profile specifying policies governing access, by said each user, to the Home VPN.

25. The Home VPN server of claim 23, wherein the Home VPN server is further arranged for authenticating each user for a device session, wherein said access policies are defined by the Home VPN user profile.

26. The Home VPN server of claim 23, wherein the Home VPN server comprises:
a Point of Presence (Home VPN PoP), wherein the Home VPN can connect to the Home VPN server by the communications device;
a Network Address and Port translator (NAPT) for translating IP-addresses and port numbers of IP-packets which are sent between the operator network and the subscriber network,
a DHCP for assigning individual IP-addresses to each device in the subscriber network; and
a router for routing IP-traffic from the communications operator network to the devices in the subscriber network.

27. The Home VPN server of claim 23, wherein the communications device is a customer premise equipment (CPE) and the Home VPN connects to the communications operator network via the CPE, by tunneling the.

28. The Home VPN server of claim 23, in which the communications device of the Home VPN can connect to the Home VPN PoP if the communications device is able to map a second L2 protocol which is used in the Home VPN to a first L2 protocol in the operator network via a “null-mapping” function which preserves the address of a subscriber device by means of which the Home VPN server can identify the subscriber device in the Home VPN.

29. The Home VPN server of claim 23, in which the Home VPN server comprises one Home VPN context per Home VPN subscriber, said context containing one instance of each function that the operator hosts for the Home VPN subscriber.

30. The Home VPN server of claim 29, in which said context can comprise a plurality of users for the Home VPN of that context, each user having individual user profiles with regard to which services of the Home VPN that they may access.
